(19) United States
(12) Patent Application Publication
(10) Pub. No.: US 2016/0189827 A1
(43) Pub. Date: Jun. 30, 2016

(54) REINFORCING-TYPE ELECTRIC WIRE

(71) Applicant: Rongqing Gao, Jiangsu (CN)

(72) Inventor: Rongqing Gao, Jiangsu (CN)

(21) Appl. No.: 14/663,301

(22) Filed: Mar. 19, 2015

(30) Foreign Application Priority Data
Dec. 26, 2014 (CN) 201420839980.X

(51) Int. Cl. H01B 7/00; H01B 3/28; H01B 3/48; H01B 1/02; H01B 3/30

(52) U.S. Cl. CPC H01B 7/0081; H01B 1/026; H01B 3/30; H01B 3/48; H01B 3/28

(57) ABSTRACT

The invention provides a reinforcing-type electric wire, including a conductive wire core and an insulating layer coated on the surface of said conductive wire core, and also includes a reinforcement core. Said conductive wire core is coated on the surface of said reinforcement core. For the reinforcing-type electric wire, the reinforcement core is provided within the conductive wire core, so that the bending resistant performance of the electric wire is improved greatly, the fatigue strength of the electric wire is much better than that of an ordinary electric wire, and the tensile strength of the electric wire is improved. The electric wire is firm in structure, also has a good electrical insulation property and an excellent anti-bending property so as to ensure the reliability and safety in the process of its use, and the service life of the electric wire is effectively prolonged.

### FIELD OF THE INVENTION

The invention relates to the field of cables, and particularly relates to a reinforcing-type electric wire.

### BACKGROUND OF THE INVENTION

The existing electric wire is internally provided with a copper wire, the periphery of which is an insulating layer. The existing electric wire is relatively low in tensile strength, and is easy to break in the process of using, for example, when a Christmas tree needs to be tied, or when a Christmas light string is tied to the Christmas tree in the Christmas lighting industry, because the tensile strength of the electric wire of the existing Christmas light string is not enough, an auxiliary electric wire needs to be added to tie the tree together. In this way, not only is installation time prolonged, but also lighting installation cost is increased.

### SUMMARY OF THE INVENTION

In order to solve the problems in the prior art, the invention provides a reinforcing-type electric wire, including a conductive wire core and an insulating layer coated on the surface of said conductive wire core, and further including a reinforcement core. Said conductive wire core is coated on the surface of said reinforcement core.

As a further improvement of this invention, said conductive wire core is formed by twisting a plurality of conductive wires, and said reinforcement core is provided within said conductive wire core.

As a further improvement of the invention, said reinforcement core is plural in number, and said conductive wire core is formed by twisting conductive wires and said reinforcement core.

As a further improvement of the invention, said reinforcement line is plastic fiber or plastic monofilament.

As a further improvement of the invention, said reinforcement core is formed by twisting a plurality of reinforcement lines.

As a further improvement of the invention, said conductive wire core is a copper wire.

The beneficial effects of the invention are that: for the reinforcing-type electric wire, the reinforcement core is provided in the conductive wire core, so that the bending resistant performance of the electric wire is improved greatly, the fatigue strength of the electric wire is much better than that of an ordinary electric wire, and the tensile strength of the electric wire is improved. The electric wire is firm in structure, also has a good electrical insulation property and an excellent anti-bending property so as to ensure the reliability and safety in the process of its use, and the service life of the electric wire is effectively prolonged.

### BRIEF DESCRIPTION OF THE DRAWINGS

FIG. 1 is a sectional schematic diagram of an embodiment of a reinforcing-type electric wire of the invention.

### DETAILED DESCRIPTION OF THE EMBODIMENTS

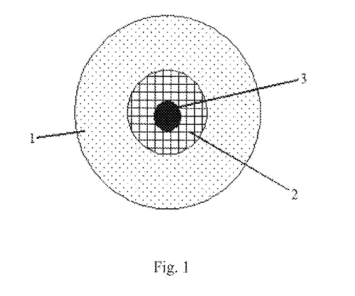

Reference signs: 1-insulating layer, 2-conductive wire core, 3-reinforcement core. As shown in FIG. 1, the invention discloses a reinforcing-type electric wire, including an insulating layer 1 and a conductive wire core 2, wherein said insulating layer 1 is coated on the outer surface of said conductive wire core 2, the interior of said conductive wire core 2 is also coated with a reinforcement core 3, and said reinforcement core 3 is made of plastic material.

In some embodiments, said conductive wire core 2 is formed by twisting a plurality of conductive copper wires, said enforcement core 3 is provided within said conductive wire core 2, and thus the strength of the electric wire is further enhanced.

In some embodiments, said reinforcement core 3 is plural in number, said conductive wire core 2 is formed by twisting the conductive wires and the reinforcement core 3 together and is also provided with another reinforcement core 3 in the middle, and thus the strength of the electric wire is further reinforced.

Said reinforcement wire core 3 may be a single plastic wire or formed by twisting a plurality of plastic fibers, so that the reinforcement effect is better.

Said insulating layer 1 includes an insulating inner rubber layer and an insulating outer rubber layer, wherein said insulating inner rubber layer is coated on the outer surface of said conductive wire core, and said insulating outer rubber layer is coated on the outside of said insulating inner rubber layer, so the insulating effect is better.

In some embodiments, the conductive wire core 2 is plural in number, each conductive wire core 2 wraps said insulating inner rubber layer to form a separate lead wire, said insulating outer rubber layer is coated on the exterior of all lead wires to form a relatively thick electric wire, and the lead wires therein can be used separately for wiring.

In the embodiment, said conductive wire core is a copper wire.

For the reinforcing-type electric wire, the reinforcement core 3 is provided within the conductive wire core 2, so that the bending resistant performance of the electric wire is improved greatly, the fatigue strength of the electric wire is much better than that of an ordinary electric wire, and the tensile strength of the electric wire is improved. The electric wire is firm in structure, also has a good electrical insulation property and an excellent anti-bending property so as to ensure the reliability and safety in the process of its use, and the service life of the electric wire is effectively prolonged. By using the reinforcing-type electric wire, a tree may be tied by using only one electric wire, thereby saving purchasing cost and tree tying time and being conductive to improving the market competitiveness of the novel Christmas light string.

The above content is described in further detail with reference to specific preferred embodiments of the invention and the specific implementation of the invention cannot be interpreted as being limited to these descriptions. A number of simple deductions or substitutions can be made by a person skilled in the art without departing from the idea of the invention, and they should also be considered to be within the protection scope of the invention.

1. A reinforcing-type electric wire, comprising a conductive wire core and an insulating layer coated on the surface of said conductive wire core, said reinforcing-type electric wire further comprising an reinforcement core, and said conductive wire core being coated on the surface of said reinforcement core.

2. The reinforcing-type electric wire of claim 1, wherein said conductive wire core is formed by twisting a plurality of conductive wires, and said reinforcement core is provided in said conductive wire core.

3. The reinforcing-type electric wire of claim 1, wherein said reinforcement core is plural in number, and said conductive wire core is formed by twisting conductive wires and said reinforcement core.

4. The reinforcing-type electric wire of claim 1, wherein said reinforcement core is plastic monofilament or plastic fiber.

5. The reinforcing-type electric wire of claim 1, wherein said reinforcement core is formed by twisting a plurality of reinforcement lines.

6. The reinforcing-type electric wire of claim 1, wherein said conductive wire core is a copper wire.
